(19) United States
(12) Patent Application Publication
(10) Pub. No.: US 2002/0094105 A1
(43) Pub. Date: Jul. 18, 2002

(54) Loudspeaker pole piece and loudspeaker assembly

(75) Inventor: Duncan Boniface, Ipswich (GB)

Correspondence Address: SHERMAN & SHERMAN, A.P.C., Seventeenth Floor, 2029 Century Park East, Los Angeles, CA, 90067, US

(73) Assignee: KH Technology Corporation, Grand Cayman (KY)

(21) Appl. No.: 10/081,609

(22) Filed: Feb. 20, 2002

(30) Foreign Application Priority Data
Feb. 20, 2001 (GB) 0104113.6

(51) Int. Cl. H04R 1/00; H04R 9/06; H04R 11/02

(52) U.S. Cl. 381/397; 381/396; 381/398; 381/412

(57) ABSTRACT

A generally cylindrical pole piece for a moving coil loudspeaker includes a blind recess in the axial end face that faces an air-permeable dust cap. The recess is lined with a plurality of spaced ribs or fins to increase the surface area available for heat dissipation. The recess and ribs are preferably tapered, to enable the pole piece to be made as a forging.

### FIELD OF THE INVENTION

The present invention relates generally to loudspeakers, and more particularly to the cooling of loudspeakers having a permanent magnet and a voice coil that causes the vibration of a diaphragm. The present invention further relates to a loudspeaker pole piece and a loudspeaker assembly.

### BACKGROUND OF THE INVENTION

A continuing problem in the construction of loudspeakers has been the dissipation of the heat that is generated in the voice coil, and that, if not dissipated, leads to degraded performance and possibly destruction of the voice coil.

Various methods have been used in the pursuit of a solution to this problem. For example, the prior art circulates cooling air over the coil by blowers or by using the movements of the diaphragm to force air over the coil. Such a configuration is generally unsatisfactory.

U.S. Pat. No. 4,378,471 to Shintaku describes a horn speaker where a pole piece is provided with a plurality of linear grooves in its front surface. However, the purpose of these grooves is not to dissipate the heat of the coil but to suppress the generation of heat in the pole by suppressing eddy currents.

U.S. Pat. No. 5,042,072 to Button describes a self-cooled loudspeaker in which the central pole piece is cup-shaped and has a number of axially extending grooves or channels in its outer surface to enable air to pass over the adjacent voice coil. A development of such configuration is described in U.S. Pat. No. 5,497,428 to Rojas where, again, peripheral channels are provided, but where the center of the pole piece is also apertured.

U.S. Pat. No. 5,909,015 to Yamamoto et al. describes a self-cooling loudspeaker in which the central pole piece is annular and cooling air is drawn in radially to pass over the coil.

In each of the three last-mentioned documents, the configuration is intended to encourage air actually to pass over and through the coil and to remove the heat at its source.

Prior art moving coil loudspeakers include an open dust cap configuration having a pole piece in the form of a solid cylinder that sits within the coil and its former, and that closes off the speaker assembly to the rear. Here, heat passes from the coil to the pole piece, but heat dissipation can only take place from the flat circular front face of the pole piece, which is of relatively small surface area, resulting in very little heat dissipation.

In another conventional moving coil loudspeaker, with a closed, non-porous dust cap, the central pole piece is an annulus with a venting hole through its center. Here, there is a convection movement of air from the apertured center of the pole piece rearwards, towards the inside of the cabinet, where the hot air is trapped.

Neither of these conventional configurations, in which the pole piece acts as a heat sink, provide adequate cooling.

### OBJECTS OF THE INVENTION

It is accordingly an object of the present invention to provide a loudspeaker pole piece and a loudspeaker assembly that overcome the hereinafore-mentioned disadvantages of the heretofore-known devices of this general type and that address the problem from a different perspective.

It is a further object of the present invention to use the pole piece itself as a medium for improved cooling of the voice coil.

### SUMMARY OF THE INVENTION

With the foregoing and other objects in view, there is provided, in accordance with the preferred embodiment of the present invention, a pole piece for a loudspeaker assembly, including a cylindrical body having an end face, the end face having a blind recess with a circumferential wall, and the circumferential wall having heat-dissipating ribs.

In the preferred embodiment of the present invention, the pole piece is first implemented as a heat sink and, then, provision is made for the heat absorbed by the pole piece to be dissipated therefrom. The preferred embodiments of the present invention, using the pole piece as a heat sink, improves the dissipation of heat from the loudspeaker.

The improvement is achieved in the preferred embodiments by the use of a pole piece having an improved shape and configuration. In accordance with the preferred embodiment of the present invention, the pole piece for a loudspeaker assembly has a generally cylindrical form about a longitudinal axis, with a blind recess in one end face, and with a plurality of heat-dissipating ribs around the circumferential wall of the recess.

In accordance with another feature of the preferred embodiments of the present invention, ribs are aligned with the longitudinal axis of the pole piece. They are preferably equispaced around the wall of the recess.

In accordance with a further feature of the preferred embodiments of the present invention, the circumferential mark/space ratio of the ribs to the gaps therebetween is approximately 1:1.

In accordance with an added feature of the preferred embodiments of the present invention, the blind recess is tapered, decreasing in diameter away from one end face of the pole piece.

In accordance with an additional feature of the preferred embodiments of the present invention, the ribs have a taper. The ribs preferably taper in conformity with the taper of the recess. The taper enables the pole piece to be manufactured as a forging, thus requiring no additional component cost and with no further operations or post-treatment or working required.

In accordance with yet another feature of the preferred embodiments of the present invention, each rib is of trapezoidal shape in horizontal cross-section through the pole piece, with a sloping radially inner face and sloping side faces.

In accordance with yet a further feature of the preferred embodiments of the present invention, the blind recess has a depth approximately half of the longitudinal length of the body of the pole piece.

In accordance with yet an added feature of the preferred embodiments of the present invention, the pole piece is forged.

In accordance with yet an additional feature of the preferred embodiments of the present invention, the ribs extend radially inward from the circumferential wall.

With the objects of the invention in view, in the preferred embodiments of the present invention, there is also provided a pole piece for a loudspeaker assembly, including a forged cylindrical body having an end face, the end face having a blind recess, the blind recess having a tapered circumferential wall decreasing in diameter away from the end face, and the circumferential wall having heat-dissipating ribs tapered in a shape corresponding to a taper of the circumferential wall.

With the objects of the invention in view, in the preferred embodiments of the present invention, there is also provided a loudspeaker assembly including a housing, a diaphragm supported by the housing, a moving coil coupled to the diaphragm, a permanent magnet encircling the coil, and a pole piece having an end face communicating with ambient atmosphere and having a blind recess with a circumferential wall having heat-dissipating ribs.

In accordance with again another feature of the preferred embodiments of the present invention, the ribbed portion of the pole piece is substantially co-extensive with the coil. Preferably, the pole piece is positioned at least partially within the coil, in particular, entirely within the coil.

In accordance with again a further feature of the preferred embodiments of the present invention, a portion of the pole piece having the ribs is substantially co-extensive with the coil.

In accordance with again an added feature of the preferred embodiments of the present invention, the circumferential wall has a wall span, the coil has a travel path, and the wall span is disposed substantially within the travel path.

With the objects of the invention in view, in the preferred embodiments of the present invention there is also provided a loudspeaker assembly, including a housing, a diaphragm supported by the housing, a moving coil having a travel path, the moving coil coupled to the diaphragm, a permanent magnet encircling the coil, a forged pole piece having an end face communicating with ambient atmosphere, the pole piece at least partially disposed within the coil, the end face having a blind recess with a tapered circumferential wall decreasing in diameter away from the end face, the circumferential wall having heat-dissipating ribs tapered in a shape corresponding to a taper of the circumferential wall, and the circumferential wall having a wall span disposed substantially within the travel path.

With the objects of the invention in view, in the preferred embodiments of the present invention a loudspeaker is provided having a housing, a diaphragm supported by the housing, a moving coil coupled to the diaphragm, a permanent magnet encircling the coil, and there is also provided a pole piece including a cylindrical body having an end face communicating with ambient atmosphere, the cylindrical body at least partially disposed within the coil, and the end face having a blind recess with a circumferential wall having heat-dissipating ribs.

By modifying the shape of the pole piece, heat dissipation is increased. A number of benefits and advantages arise from such a construction. First, there is increased heat dissipation from the loudspeaker motor assembly, leading to improved power handling, greater reliability, reduced thermal compression and reduced distortion. Second, there is more even heat dissipation over the length of the coil, giving improved linearity and therefore reducing distortion. Third, there is a reduced volume of steel required for the pole piece, leading to a reduction in weight for the assembly and also reduced cost.

Other features that are considered as characteristic for the invention and its preferred embodiments are set forth in the appended claims.

Although the preferred embodiments of the present invention is illustrated and described herein as embodied in a loudspeaker pole piece and a loudspeaker assembly, the invention is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a cross-sectional view through a loudspeaker assembly incorporating a pole piece according to a first preferred embodiment of the present invention;

FIG. 2 is a plan view of the pole piece of FIG. 1 showing the rib configuration;

FIG. 3 is a fragmentary, cross-sectional view through the pole piece along line III-III in FIG. 2.

FIG. 4 is a plan view of the second preferred embodiment of pole piece, on an enlarged scale; and

FIG. 5 is an enlarged detail view of the zone indicated by broken lines and the numeral V in FIG. 4.

### DESCRIPTION OF THE PREFERRED EMBODIMENTS

In the figures of the drawings, unless stated otherwise, identical reference symbols denote identical parts.

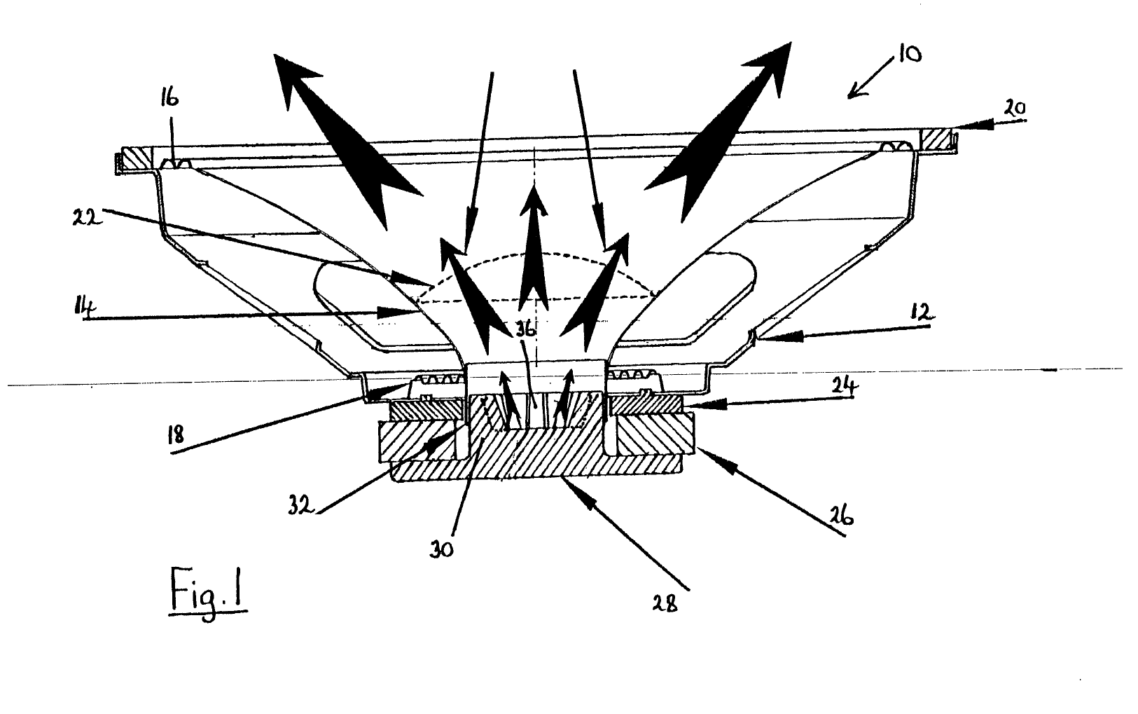

Referring now to the figures of the drawings in detail and first, particularly to FIG. 1 thereof, there is shown a loudspeaker assembly 10 constructed according to the preferred embodiments of the present invention including a housing or chassis 12 from which a cone 14 is suspended by a front suspension 16 and a rear suspension 18. The front suspension 16 is mounted to the housing by an annular gasket 20. Within the cone 14 is a dust cap 22 that is porous, i.e., permeable to air.

Secured by non-illustrated screws to the back of the housing 12 is a front plate 24 of the magnet assembly. Rearwardly of the front plate 24 is an annular magnet 26, to which is fixed a pole piece or yoke 28. The pole piece 28 has a central boss 30 that extends axially through the magnet and front plate, defining an annular voice coil gap around the pole piece. Within this gap is located a voice coil 32 carried by a cylindrical former secured to the cone 14.

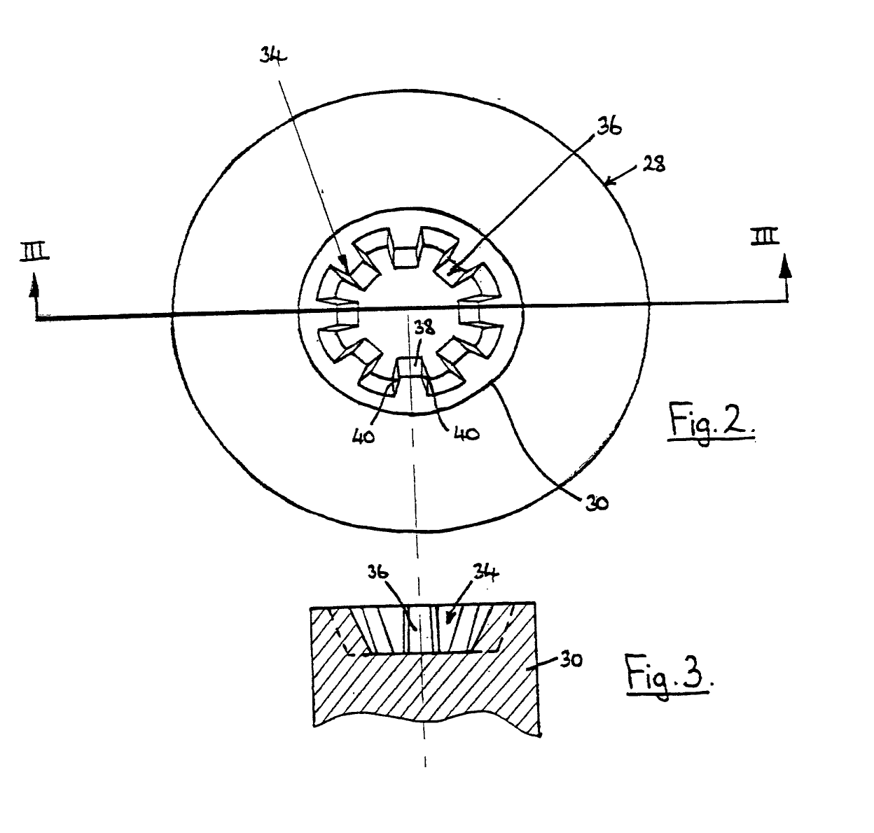

As shown in FIG. 2, the pole piece boss 30 of a first preferred embodiment of the present invention has a blind recess 34 in its axial end face that faces the dust cap 22. The internal wall of the recess 34 is provided with a plurality of projecting ribs or fins 36 that extend the full depth of the recess.

Eight ribs 36 are shown in FIG. 2, but a greater or lesser number could be provided. The ribs 36 are preferably equispaced, as shown. In the first illustrated preferred embodiment, the mark-to-space ratio of the ribs to the grooves between them is approximately 1 to 1. The recess 34 is slightly tapered, as are the ribs 36. The tapering enables the pole piece to be made by a forging process. Consequently, each rib 36 has a radially sloping inner surface 38 and sloping sides 40. In horizontal cross-section, each rib 36, therefore, has a trapezoidal shape.

Although the ribs 36 and the interstices between them of the first preferred embodiment are shown in FIGS. 2 and 3 with sharp edges and corners, these edges and corners could be rounded to help the metal to flow into shape in the forging process. The radially inwardly facing surface of each rib 36 would then not be flat as shown, but slightly convex.

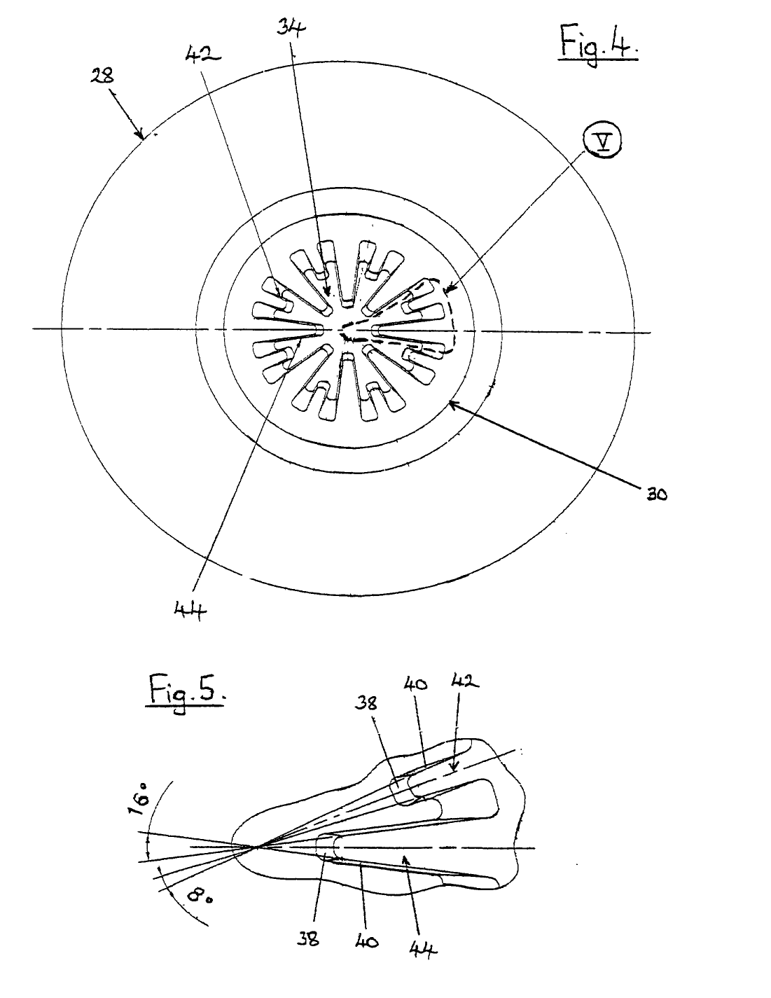

Referring now to FIGS. 4 and 5, a second preferred embodiment of pole piece 28 is shown. In this second embodiment, instead of having eight ribs of equal size as in the first embodiment, here eight small ribs 42 alternate with eight large ribs 44.

Each small rib 42 is set midway between the larger ribs 44 on each side thereof. The larger ribs 44 extend radially inwards towards the center of the blind recess 34.

The radial dimension of each of the larger ribs 44 is approximately twice that of the smaller ribs 42. As can be seen from the drawings, the amount of taper in the radial direction is greater for the larger ribs 44. As shown, it is approximately twice as great, e.g. 16° as compared with 8°. Also, in contrast to the sharp-edged ribs of the first embodiment, the ribs 42 and 44 have rounded edges.

The primary purpose of providing alternate large and small ribs 44, 42 is to increase the surface area from which heat can be dissipated. Given that a forging process will have a lower limit for the rib thickness, ribs of equal radial length all round would have to be shorter to prevent them from joining together as they near the central axis of the pole piece. Alternative long and short ribs give a greater surface area, but due to the lower limit for rib thickness this configuration is more practical for relatively large diameter pole pieces.

The depth of the recess 34 is a matter of choice, although a depth equal to about half the axial length of the pole piece 28 is generally suitable. What is important is that the depth of the recess 34 should be sufficient so that it substantially spans the path of travel of the voice coil 32. In other words, no matter in what position the voice coil 32 is located, the greater part of its axial length should be opposed, across the voice coil gap, by the ribbed wall of the pole piece.

The provision of the ribs 36, 42, 44 dramatically increases the surface area available for heat dissipation. Air can flow in to the center of the pole piece, enabling cooling close to the coil over the whole of the path of travel of the coil. By such a construction, the creation of steep temperature gradients along the axial length of the coil is avoided. In the conventional pole piece configuration referred to above, where heat is only dissipated from the front or rear of the pole piece, i.e., some way from the coil position, in the invention, steep temperature gradients along the coil are obtained, which reduces the linearity of the cone movement.

In use, hot air within the pole piece escapes by convection and by radiation through the dust cap 22, thereby drawing in cool air to continue the cooling process. The hot air escapes into the ambient atmosphere, not into the loudspeaker cabinet. Such transfer ensures a relatively constant dissipation of heat.

It is to be understood that the construction and configuration of ribs shown in the illustrated embodiments is by way of example only. The number, shape and orientation of the ribs or fins can be varied from that shown without exceeding the scope of the invention.

I claim:

1. A pole piece for a loudspeaker assembly, comprising:
a cylindrical body having an end face;
said end face having a blind recess with a circumferential wall; and
said circumferential wall having heat-dissipating ribs.

2. The pole piece according to claim 1, wherein:
said body has a longitudinal axis; and
said ribs are aligned with said longitudinal axis.

3. The pole piece according to claim 1, wherein said ribs are equispaced around said circumferential wall.

4. The pole piece according to claim 1, wherein:
said body has a longitudinal axis; and
said ribs are evenly spaced about said longitudinal axis.

5. The pole piece according to claim 1, wherein a circumferential mark to space ratio of said ribs to gaps therebetween is approximately 1:1.

6. The pole piece according to claim 1, wherein:
said ribs define gaps therebetween;
said ribs have a given width;
said gaps have a set width; and
a ratio of said given width to said set width is substantially 1:1.

7. The pole piece according to claim 1, wherein said blind recess has a taper decreasing in diameter away from said end face.

8. The pole piece according to claim 7, wherein said ribs have a taper.

9. The pole piece according to claim 8, wherein said taper of said ribs corresponds to said taper of said blind recess.

10. The pole piece according to claim 7, wherein each of said ribs has a trapezoidal shape with respect to a horizontal cross-section through said body.

11. The pole piece according to claim 10, wherein each of said ribs has a radially sloping inner face and sloping side faces.

12. The pole piece according to claim 1, wherein each of said ribs has a trapezoidal shape with respect to a horizontal cross-section through said body.

13. The pole piece according to claim 12, wherein each of said ribs has a radially sloping inner face and sloping side faces.

14. The pole piece according to claim 1, wherein each of said ribs has a radially sloping inner face and sloping side faces.

15. The pole piece according to claim 1, wherein:
said body has a longitudinal length; and
said blind recess has a depth approximately half of said longitudinal length.

16. The pole piece according to claim 1, wherein said body is forged.

17. The pole piece according to claim 1, wherein said ribs extend radially inward from said circumferential wall.

18. A pole piece according to claim 1, wherein the ribs comprise alternate ribs such that there are radially longer ribs and radially shorter ribs.

19. A pole piece according to claim 18, wherein the radially longer ribs are approximately twice as long as the radially shorter ribs.

20. A pole piece according to claim 18, wherein each rib has a radial taper, decreasing in width away from the circumferential wall, and with that radial taper of the longer ribs being greater than the radial taper of the shorter ribs.

21. A pole piece for a loudspeaker assembly, comprising:
a forged cylindrical body having an end face;
said end face having a blind recess;
said blind recess having a tapered circumferential wall decreasing in diameter away from said end face; and
said circumferential wall having heat-dissipating ribs tapered in a shape corresponding to a taper of said circumferential wall.

22. A loudspeaker assembly, comprising:
a housing;
a diaphragm supported by said housing;
a moving coil coupled to said diaphragm;
a permanent magnet encircling said coil;
a pole piece having an end face communicating with ambient atmosphere;
said pole piece at least partially disposed within said coil; and
said end face having a blind recess with a circumferential wall having heat-dissipating ribs.

23. The loudspeaker assembly according to claim 21, wherein a portion of said pole piece having said ribs is substantially co-extensive with said coil.

24. The loudspeaker assembly according to claim 21, wherein:
said circumferential wall has a wall span;
said coil has a travel path; and
said wall span is disposed substantially within said travel path.

25. A loudspeaker assembly, comprising:
a housing;
a diaphragm supported by said housing;
a moving coil having a travel path;
said moving coil coupled to said diaphragm;
a permanent magnet encircling said coil;
a forged pole piece having an end face communicating with ambient atmosphere;
said pole piece at least partially disposed within said coil;
said end face having a blind recess with a tapered circumferential wall decreasing in diameter away from said end face;
said circumferential wall having heat-dissipating ribs tapered in a shape corresponding to a taper of said circumferential wall; and
said circumferential wall having a wall span disposed substantially within said travel path.

26. In a loudspeaker having a housing, a diaphragm supported by the housing, a moving coil coupled to the diaphragm, a permanent magnet encircling the coil, a pole piece comprising:
a cylindrical body having an end face communicating with ambient atmosphere;
said cylindrical body at least partially disposed within the coil; and
said end face having a blind recess with a circumferential wall having heat-dissipating ribs.
